(19) United States
(12) Patent Application Publication
(10) Pub. No.: US 2025/0256550 A1
(43) Pub. Date: Aug. 14, 2025

(54) VENT ASSEMBLY

(71) Applicant: Rivian IP Holdings, LLC, Irvine, CA (US)

(72) Inventors: Shukan Shitalkumar PAREKH, Costa Mesa, CA (US); William Kirk ROBINSON, Newport Beach, CA (US); Suhant RANGA, Novi, MI (US); Marcus Edward MERIDETH, Irvine, CA (US); Jose Benjamin FLORES SUAREZ, Irvine, CA (US)

(21) Appl. No.: 19/051,037

(22) Filed: Feb. 11, 2025

Related U.S. Application Data
(60) Provisional application No. 63/553,578, filed on Feb. 14, 2024.

(51) Int. Cl. B60H 1/34; B60H 1/00; B60H 1/24

(52) U.S. Cl. CPC B60H 1/3421; B60H 1/00021; B60H 1/00421; B60H 1/00871; B60H 1/242; B60H 2001/00092

(57) ABSTRACT

A vent assembly can transition between multiple configurations to provide various types of airflow. A vent assembly can include multiple groups of vanes that can be separately controlled to direct airflow in the same or different directions. Such directional control can include a cam-based mechanism to aim multiple vents in both one or more common directions and one or more different (e.g., opposing) directions. The cam mechanism can be operated to aim the multiple vents (e.g., of each group) in each of a common first direction, a common second direction, and in opposing directions.

### CROSS REFERENCE TO RELATED APPLICATIONS

This application claims the benefit of priority to U.S. Provisional Patent Application No. 63/553,578, entitled, “VENT ASSEMBLY”, filed on Feb. 14, 2024, the disclosure of which is hereby incorporated herein in its entirety.

### INTRODUCTION

The present description relates generally to vehicles. More particularly, the present disclosure relates to vent assemblies for vehicles. Vehicles are often provided with heating ventilation and air conditioning (HVAC) systems.

### SUMMARY

Embodiments of the present disclosure are directed toward a vent assembly that can transition between multiple configurations to provide various types of airflow. A vent assembly can include multiple groups of vanes that can be separately controlled to direct airflow in the same or different directions. Aspects of the subject technology can provide airflow directional control that includes a cam-based mechanism to aim multiple vents in both one or more common directions and one or more different (e.g., opposing) directions. For example, the vents can be provided in groups. The cam mechanism can be operated to aim the multiple vents (e.g., of each group) in each of a common first direction, a common second direction, and in opposing directions. The vents can be directed to provide parallel air streams, converging air streams (e.g., “toe-in”), and/or diverging air steams (e.g., “toe-out”).

In accordance with aspects of the subject technology, an apparatus is provided that includes one or more first vanes; one or more second vanes; a first follower coupled to each of the one or more first vanes; a second follower coupled to each of the one or more second vanes; and a rotatable cam. The rotatable cam may include a first cam portion having multiple first lobes to form a first shape, the first follower engaging the first cam portion; and a second cam portion having multiple second lobes to form a second shape, different than the first shape, the second follower engaging the second cam portion.

The rotatable cam may be configured to be rotated to transition the apparatus between: a first configuration with the one or more first vanes and the one or more second vanes facing a first direction; a second configuration with the one or more first vanes and the one or more second vanes facing a second direction, different than the first direction; and a third configuration with the one or more first vanes facing the first direction and the one or more second vanes facing the second direction. In the third configuration, the one or more first vanes and the one or more second vanes are directed to provide a diverging flow of air. In the third configuration, the one or more first vanes and the one or more second vanes are directed to provide a converging flow of air.

The first cam portion may be on a first side of the cam, and the second cam portion may be on a second side of the cam, opposite the first side. The apparatus may further include a first arm coupling each of the one or more first vanes to the first follower; and a second arm coupling each of the one or more second vanes to the second follower. The rotatable cam may define: a first channel extending about the first cam portion, the first channel having a first terminal end and a second terminal end; and a second channel extending about the second cam portion, the first channel having a third terminal end and a fourth terminal end. The multiple first lobes may be distributed about a continuous first outer periphery of the first cam portion; and the multiple second lobes may be distributed about a continuous second outer periphery of the second cam portion. The apparatus may further include: a first spring configured to bias the first follower against the first cam portion; and a second spring configured to bias the second follower against the second cam portion. The one or more first vanes and the one or more second vanes are each located within a passenger compartment of a vehicle.

In accordance with aspects of the subject technology, a method is provided that includes: rotating a cam to a first orientation to urge one or more first vanes and one or more second vanes to a first configuration with the one or more first vanes and the one or more second vanes facing a first direction; rotating the cam to a second orientation to urge the one or more first vanes and the one or more second vanes to a second configuration with the one or more first vanes and the one or more second vanes facing a second direction, different than the first direction; and rotating the cam to a third orientation to urge first vanes and second vanes to a third configuration with the one or more first vanes facing the first direction and the one or more second vanes facing the second direction.

While the cam is in the first orientation, a first upper lobe of an upper cam portion of the cam may urge the one or more first vanes to face the first direction and a first lower lobe of a lower cam portion of the cam urges the one or more second vanes to face the first direction. While the cam is in the second orientation, a second upper lobe of the upper cam portion of the cam may urge the one or more first vanes to face the second direction and a second lower lobe of the lower cam portion of the cam urges the one or more second vanes to face the second direction. While the cam is in the third orientation, a third upper lobe of the upper cam portion of the cam may urge the one or more first vanes to face the first direction and a third lower lobe of the lower cam portion of the cam urges the one or more second vanes to face the second direction.

Rotating the cam to the first orientation may be in response to a first command signal; rotating the cam to the second orientation may be in response to a second command signal; and rotating the cam to the third orientation may be in response to a third command signal. The method may further include: detecting a current orientation of the cam; determining a direction of rotation of the cam corresponding to a shortest rotational motion to a target orientation, wherein the target orientation is one of the first orientation, the second orientation, or the third orientation; and rotating the cam in the direction of rotation. The method may further include: detecting when the cam is in a fourth orientation in which a follower abuts a first terminal end of the cam; detecting the cam to a fifth orientation in which the follower abuts a second terminal end of the cam; and in response to a detection of the fourth orientation and a detection of the fifth orientation, determining a calibration factor for controlling rotation of the cam to each of the first orientation, the second orientation, and the third orientation.

In accordance with aspects of the subject technology, an apparatus is provided that includes one or more first vanes coupled to a first outer gear; one or more second vanes coupled to a second outer gear and an arm; and an inner gear. The inner gear may include first inner teeth for selectively engaging the first outer gear; and second inner teeth for selectively engaging the second outer gear; an engager for selectively engaging the arm.

The inner gear may be configured to be rotated to transition the apparatus between: a first configuration with the one or more first vanes and the one or more second vanes facing a first direction while the first inner teeth engage the first outer gear and the second inner teeth engage the second outer gear; a second configuration with the one or more first vanes and the one or more second vanes facing a second direction, different than the first direction, while the first inner teeth engage the first outer gear and the second inner teeth engage the second outer gear; and a third configuration with the one or more first vanes facing the first direction and the one or more second vanes facing the second direction while the engager engages the arm.

The apparatus may further include a spring configured to bias the one or more second vanes to face in the second direction. The first inner teeth and the second inner teeth may be positioned on opposing sides of the inner gear. The one or more first vanes and the one or more second vanes may be each located within a passenger compartment of a vehicle.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having one or more vents in accordance with one or more implementations.

FIG. 2 illustrates a schematic top view of a vehicle having vents in accordance with one or more implementations.

FIG. 3A illustrates a top view of a vent assembly with vanes in a neutral configuration in accordance with one or more implementations.

FIG. 3B illustrates a top view of the vent assembly of FIG. 3A with the vanes in a first aligned configuration in accordance with one or more implementations.

FIG. 3C illustrates a top view of the vent assembly of FIGS. 3A and 3B with the vanes in a second aligned configuration in accordance with one or more implementations.

FIG. 3D illustrates a top view of the vent assembly of FIGS. 3A-3C with the vanes in a split configuration in accordance with one or more implementations.

FIG. 3E illustrates a top view of the vent assembly of FIGS. 3A-3D with the vanes in a converging configuration in accordance with one or more implementations.

FIG. 4A illustrates a perspective view of a vent assembly in accordance with one or more implementations.

FIG. 4B illustrates a perspective view of a portion of the vent assembly of FIG. 4A in accordance with one or more implementations.

FIG. 4C illustrates another perspective view of a portion of the vent assembly of FIG. 4A in accordance with one or more implementations.

FIG. 4D illustrates a top view of a cam of a vent assembly of in accordance with one or more implementations.

FIG. 4E illustrates a bottom view of the cam of FIG. 4D in accordance with one or more implementations.

FIG. 5A illustrates a perspective view of a vent assembly in accordance with one or more implementations.

FIG. 5B illustrates a top view of a portion of the vent assembly of FIG. 5A in accordance with one or more implementations.

FIG. 6A illustrates a top view of a vent assembly with vanes in a neutral configuration in accordance with one or more implementations.

FIG. 6B illustrates a top view of the vent assembly of FIG. 6A with the vanes in a first aligned configuration in accordance with one or more implementations.

FIG. 6C illustrates a top view of the vent assembly of FIGS. 6A and 6B with the vanes in a second aligned configuration in accordance with one or more implementations.

FIG. 6D illustrates a top view of the vent assembly of FIGS. 6A-6C with the vanes in a split configuration in accordance with one or more implementations.

FIG. 7 illustrates a flow chart of illustrative operations that may be performed for controlling a vent assembly in accordance with one or more implementations.

FIG. 8 illustrates a flow chart of illustrative operations that may be performed for calibrating a vent assembly in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Apparatuses, such as vehicles, buildings, and/or other enclosed and/or indoor spaces are often provided with ventilation systems, such as heating ventilation and air conditioning (HVAC) systems. Ventilation systems often include a blower or other air-moving component configured to move air from one or more inlets to one or more outlet vents. One or more of the outlet vents may have a feature to direct the air in a particular direction at a given time. Such a feature can be controlled to modify the direction in which the air is directed across time.

Changing the direction of airflow can be achieved with multiple actuators with various types of assemblies for aiming the interior air vents in different directions electronically. However, such systems can be expensive and complicated.

Embodiments of the present disclosure are directed toward a vent assembly that can transition between multiple configurations to provide various types of airflow. A vent assembly can include multiple groups of vanes that can be separately controlled to direct airflow in the same or different directions. Aspects of the subject technology can provide airflow directional control that includes a cam-based mechanism to aim multiple vents in both one or more common directions and one or more different (e.g., opposing) directions. For example, the vents can be provided in groups. The cam mechanism can be operated to aim the multiple vents (e.g., of each group) in each of a common first direction, a common second direction, and in opposing directions. The vents can be directed to provide parallel air streams, converging air streams (e.g., “toe-in”), and/or diverging air steams (e.g., “toe-out”).

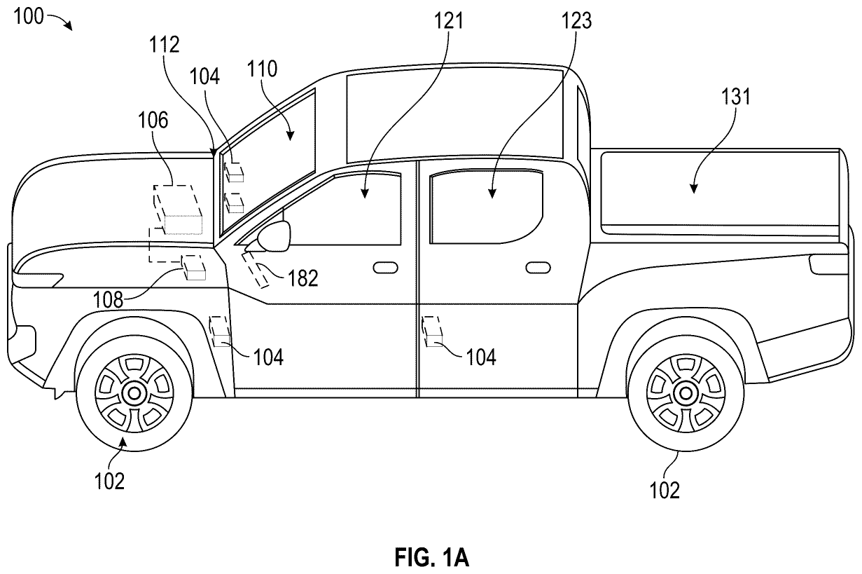

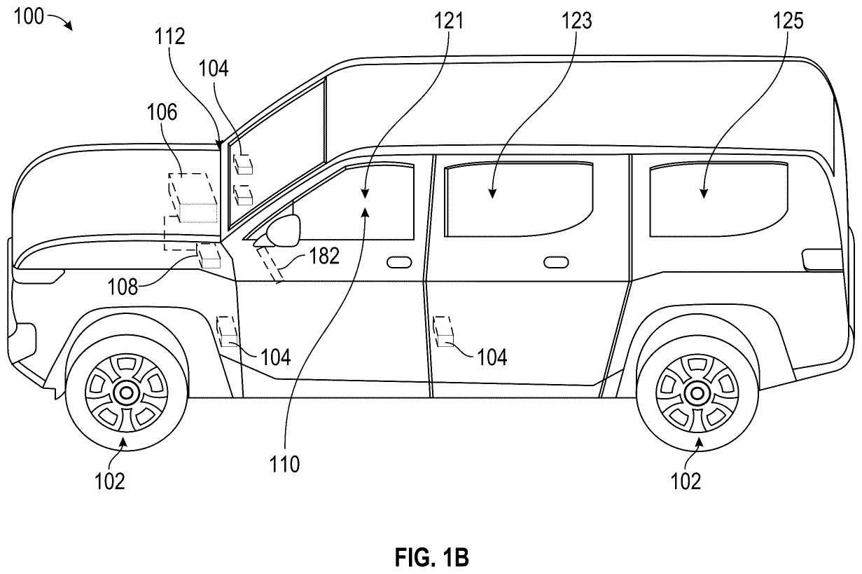

FIG. 1A is a diagram illustrating an example implementation of an apparatus as described herein. In the example of FIG. 1A, the apparatus is a moveable apparatus implemented as a vehicle 100. In one or more implementations, the vehicle 100 may be implemented as an electric vehicle and may include one or more batteries for powering the vehicle and/or one or more systems and/or components of the vehicle.

For example, in one or more implementations, the vehicle 100 may be an electric vehicle having one or more electric motors that drive the wheels 102 of the vehicle using electric power from the battery. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a ventilation system (e.g., an HVAC) system. For example, the vehicle 100 (e.g., the HVAC system of the vehicle) may include a blower 106 and one or more outlet vents 104. As shown, the vehicle 100 may also include processing circuitry 108 (e.g., one or more processors, memory, and/or communications circuitry). The processing circuitry 108 may be communicatively coupled to the blower 106, for control, by the processing circuitry 108, of the blower 106 (e.g., to control an amount of power that is provided to the blower 106, such as from a battery of the vehicle 100).

As shown, the vehicle 100 may include multiple outlet vents 104 (e.g., also referred to herein as vents) within a passenger compartment 110 of the vehicle 100. As shown, the vents 104 may include vents that are disposed in a front portion 121 of the passenger compartment 110, a rear portion 123 of the passenger compartment 110, and/or other portions of the passenger compartment 110. The outlet vents 104 may include face vents or dash-mounted vents, floor vents, defrost vents, side vents, and/or other vents.

The blower 106, or another air-moving component, may be configured to move air from an inlet 112 (e.g., an external inlet at or near the base of the windshield or elsewhere on the exterior of the vehicle, and/or an internal (recirculation) inlet on or near a dashboard within the passenger compartment 110 of the vehicle or elsewhere within the passenger compartment 110 of the vehicle) to the one or more outlet vents 104. The inlet 112 may be switchable from a fresh air configuration or external air configuration (e.g., in which air is pulled into the inlet 112 from outside the vehicle) to a recirculation configuration (e.g., in which air is pulled into the inlet 112 from within the passenger compartment 110 of the vehicle).

As examples, the processing circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., blower 106, cameras, motion sensors, proximity sensors, etc.). The processor(s) of the processing circuitry 108 may execute instructions stored in the memory of the processing circuitry 108, such as to execute hardware, firmware, and/or software processes in order to perform the processes of the subject disclosure.

As shown in FIG. 1A, the vehicle 100 may include a control panel 182 (e.g., a touchscreen control panel). The control panel 182 of the vehicle 100 may be communicatively coupled to the processing circuitry 180, and may provide controls (e.g., buttons, knobs, switches, and/or a touch-screen user interface) for operating various components and/or features of the vehicle 100 (e.g., climate control, audio control, etc.).

The example of FIG. 1A, in which the vehicle 100 is implemented as a pickup truck having a truck bed 131, is merely illustrative. For example, FIG. 1B illustrates another implementation in which the vehicle 100 including the outlet vents 104, the blower 106, the processing circuitry 108, and the inlet 112 is implemented as a sport utility vehicle (SUV), such as an electric sport utility vehicle. In the example of FIG. 1B, the vehicle 100 including the outlet vents 104, the blower 106, the processing circuitry 108, and the inlet 112 may include a cargo storage area 125 and/or a third row of seats in at least a rear portion of the vehicle that is enclosed within the passenger compartment 110 the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having outlet vents 104, a blower 106, processing circuitry 108, and an inlet 112.

In one or more implementations, the outlet vents 104, the blower 106, the processing circuitry 108, and the inlet 112 as described herein may also, or alternatively, be implemented in another apparatus, such as a building (e.g., a residential home or commercial building, or any other building) or other stationary apparatus.

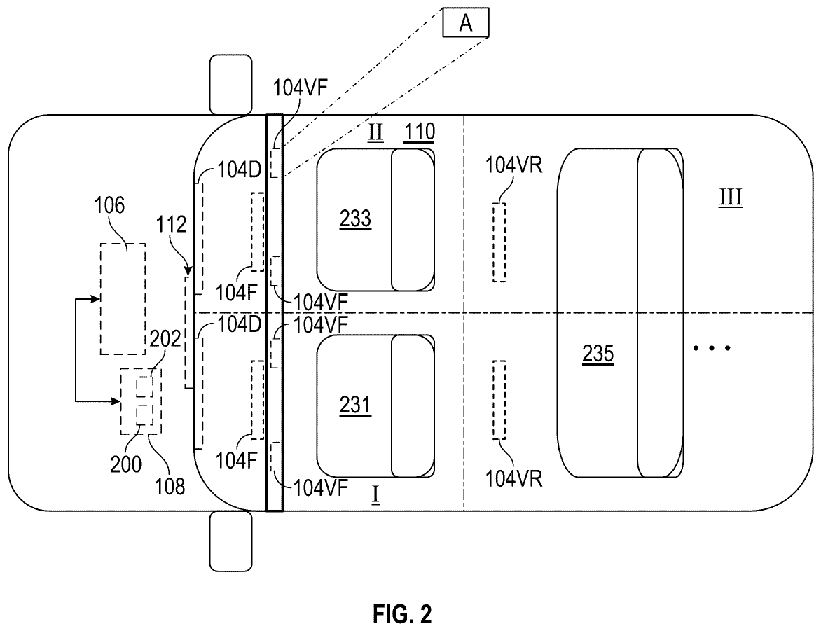

FIG. 2 depicts a schematic top view of the vehicle 100 in accordance with one or more implementations. As shown in FIG. 2, the outlet vents 104 may include one or more face vents 104VF (also referred to as dash-mounted vents), one or more floor vents 104F, one or more defrost vents 104D, and/or one or more rear vents 104VR. As shown, the rear vents 104VR may be located in a rear zone III (e.g., corresponding to the rear portion 123 of FIGS. 1A or 1B) of the passenger compartment 110 (e.g., for providing airflow for passengers in a rear seat of the vehicle 100). For example, the rear zone III may include one or more rows of rear passenger seats 235. As shown, the face vents 104VF may include one or more (e.g., multiple) face vents in each of one or more front zones (e.g., a driver zone I in which a driver seat 231 is disposed and/or a passenger zone II in which a passenger seat 233, such as a front passenger seat is disposed) of the passenger compartment 110. As shown, the floor vents 104F may include one or more (e.g., multiple) floor vents in each of the one or more front zones (e.g., the driver zone I and/or the passenger zone II) of the passenger compartment 110. As shown, the defrost vents 104D may include one or more (e.g., multiple) defrost vents in each of the one or more front zones (e.g., the driver zone I and/or the passenger zone II) of the passenger compartment 110. As indicated in FIG. 2, each vent 104 (e.g., each of the face vents 104VF, the floor vents 104F, the defrost vents 104D, and the rear vents 104VR) may have a respective area, A, such as a cross-sectional area across the opening of the vent to the passenger compartment. Although a single area, A, is depicted in FIG. 2, it is appreciated that each vent may have its own cross-sectional area, and thus its own corresponding value of the area, A.

In one or more implementations, some or all of the outlet vents 104 (e.g., some or all of the face vents 104VF, the floor vents 104F, the defrost vents 104D, and/or the rear vents 104VR) may be switchable between an open configuration and a closed configuration. In the open configuration, a vent 104 may be open to allow airflow generated by the blower 106 to flow through that vent into the passenger compartment 110. In the closed configuration, a vent 104 may be closed to prevent airflow generated by the blower 106 from flowing through that vent into the passenger compartment 110. The vents 104 may be switchable between binary fully open (e.g., with an outlet area, A) and fully closed (e.g., with an outlet area of zero) configuration, or may be controllable to (e.g., smoothly) adjust the area of the outlet vent to areas. A′, between the fully open area, A, and the zero area of the closed vent.

In one or more implementations, some or all of the outlet vents 104 (e.g., some or all of the face vents 104VF, the floor vents 104F, the defrost vents 104D, and/or the rear vents 104VR) can be provided with directional control. In each configuration, a given vent 104 and/or portions thereof may direct airflow generated by the blower 106 to flow in one or more directions into the passenger compartment 110. Different vents 104 and/or different portions of a given vent 104 can be coupled to a common directional control mechanism, such that one or more vents 104 and/or vanes thereof can be controlled to be pointed in a particular direction or in different directions based on operation of a single directional control mechanism, as described further herein.

As described herein, the inlet 112 may be switchable between an external air inlet and a recirculation input. The external air inlet and the recirculation inlet may have different inlet areas. In one or more implementations, the processing circuitry 108 may select between different parameter determination modes for controlling the blower 106, based on the inlet area of the inlet 112 (e.g., based on whether the inlet 112 is switched to the external air inlet or the recirculation inlet), as described in further detail hereinafter. For example, the processing circuitry 108 (e.g., memory of the processing circuitry 108) may store multiple computation blocks and/or lookup tables that can be selected for determining control parameters for the blower based on the inlet area.

As one illustrative example, the processing circuitry 108 may store multiple lookup tables (e.g., a first lookup table 200 and a second lookup table 202) that can be selected for parameter determination based on a target direction of airflow. For example, the first lookup table 200 may be selected if the vent 104 is to direct air in a first direction, and the second lookup table 202 may be selected if the vent 104 is to direct air in a second direction. Each of the lookup tables may provide, for a given one or more vents 104, a control parameter and/or calibration factor for directing airflow in a desired direction.

For simplicity of the figure, the blower 106, the inlet 112, and the various outlet vents 104 are shown in FIG. 2 without showing ducting therebetween for routing airflow from the inlet 112 to the blower 106, and from the blower 106 to the various outlet vents 104. However, it is appreciated that ducting may be provided between the inlet 112 and the blower 106, and between the blower 106 and the various outlet vents 104, such that airflow generated by the blower 106 causes air to flow into the blower 106 from the inlet 112 and air to flow from the blower 106 to the various outlet vents 104.

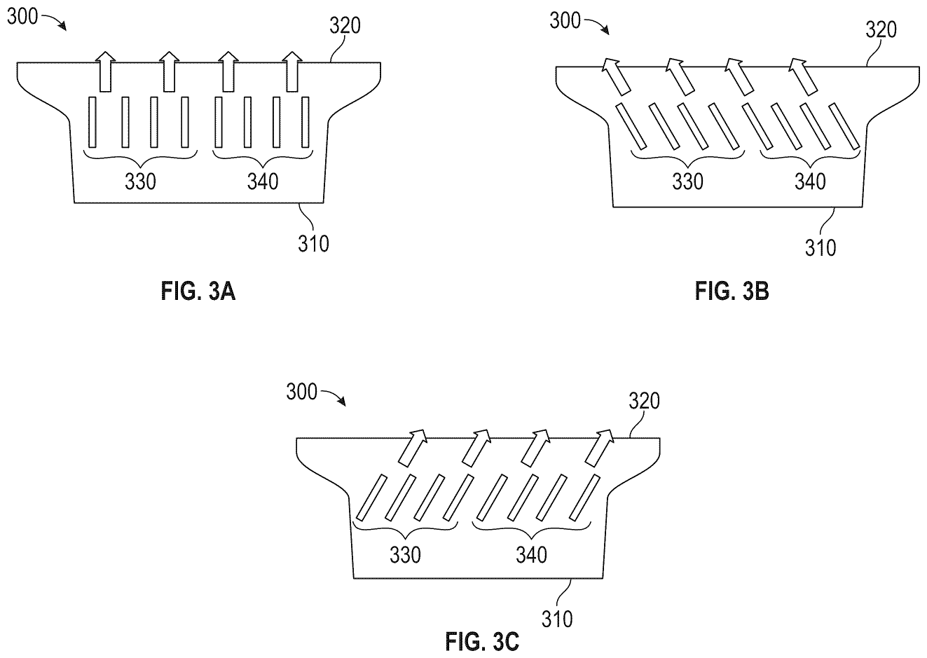

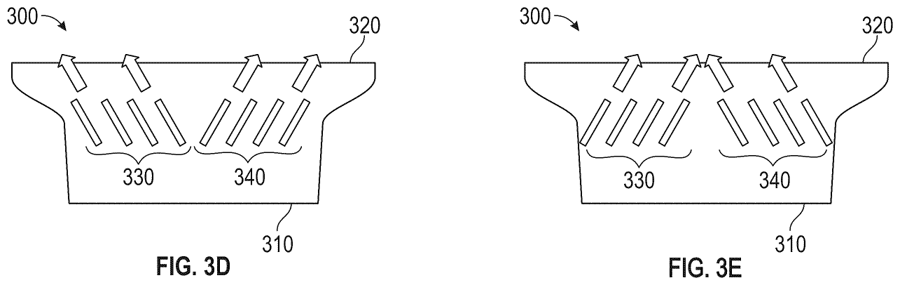

Referring now to FIGS. 3A-3E, a vent assembly can provide an ability to transition between different configurations to direct airflow in various directions. In some embodiments, the vent assembly 300 of FIGS. 3A-3E corresponds to some or all of the outlet vents 104 (e.g., some or all of the face vents 104VF, the floor vents 104F, the defrost vents 104D, and/or the rear vents 104VR) of FIGS. 1A-2. As shown in FIGS. 3A-3E, the vent assembly 300 can include multiple vanes, such as first vanes 330 and second vanes 340, each in a corresponding group or set (e.g., on a respective lateral side of the vent assembly 300). The first vanes 330 and the second vanes 340 can be controlled simultaneously to transition between one of multiple possible orientations to direct airflow from an inlet side 310 to an outlet side 320 of the vent assembly 300. While only two sets of vanes are illustrated, it will be understood that the vent assembly 300 can include any number of vanes and/or sets of vanes with coordinated control abilities.

As shown in FIG. 3A, the first vanes 330 and the second vanes 340 of the vent assembly 300 can be provided in a neutral configuration. In the neutral configuration, the first vanes 330 and the second vanes 340 can be oriented to direct air in a neutral direction, such as a direction that is orthogonal to the outlet side 320 of the vent assembly 300. The first vanes 330 and the second vanes 340 can have the same orientation (e.g., in parallel) to provide consistent flow in the neutral direction.

As shown in FIG. 3B, the first vanes 330 and the second vanes 340 of the vent assembly 300 can be provided in a first configuration. In the first configuration, the first vanes 330 and the second vanes 340 can be oriented to direct air in a first (e.g., left) direction, such as a direction that is transverse to the outlet side 320 of the vent assembly 300 and/or different from the neutral direction. In the first configuration, each of the first vanes 330 and the second vanes can be rotated and/or canted relative to the neutral configuration. The first vanes 330 and the second vanes 340 can have the same orientation (e.g., in parallel) to provide consistent flow in the first direction.

As shown in FIG. 3C, the first vanes 330 and the second vanes 340 of the vent assembly 300 can be provided in a second configuration. In the second configuration, the first vanes 330 and the second vanes 340 can be oriented to direct air in a second (e.g., right) direction, such as a direction that is transverse to the outlet side 320 of the vent assembly 300 and/or different from the neutral direction and/or the second direction. In the first configuration, each of the first vanes 330 and the second vanes can be rotated and/or canted relative to the neutral configuration. The first vanes 330 and the second vanes 340 can have the same orientation (e.g., in parallel) to provide consistent flow in the second direction.

As shown in FIG. 3D, the first vanes 330 and the second vanes 340 of the vent assembly 300 can be provided in a third configuration. In the third configuration, the first vanes 330 and the second vanes 340 can be oriented to direct air in different (e.g., rotated and/or canted) directions, such as directions that are transverse to the outlet side 320 of the vent assembly 300 and/or different from the neutral direction. For example, the first vanes 330 can be oriented to direct air in the first direction, and the second vanes 340 can be oriented to direct air in the second direction. The first vanes 330 and the second vanes 340 can have different orientations relative to each other to provide flow in different directions (e.g., away from each other and/or with diverging airflow).

As shown in FIG. 3E, the first vanes 330 and the second vanes 340 of the vent assembly 300 can be provided in a fourth configuration. In the fourth configuration, the first vanes 330 and the second vanes 340 can be oriented to direct air in different (e.g., rotated and/or canted) directions, such as directions that are transverse to the outlet side 320 of the vent assembly 300 and/or different from the neutral direction. For example, the first vanes 330 can be oriented to direct air in the second direction, and the second vanes 340 can be oriented to direct air in the first direction. The first vanes 330 and the second vanes 340 can have different orientations relative to each other to provide flow in towards a common target (e.g., towards each other and/or with converging airflow).

While only five configurations are illustrated in FIGS. 3A-3E, it should be understood that the vent assembly 300 can provide any number of discrete configurations, each with respective orientations of the first vanes 330 and the second vanes 340. Such additional configurations can include transitional stages between the configurations illustrated herein. In some embodiments, any one of one or more configurations can be controllably achieved and maintained for any desired time duration.

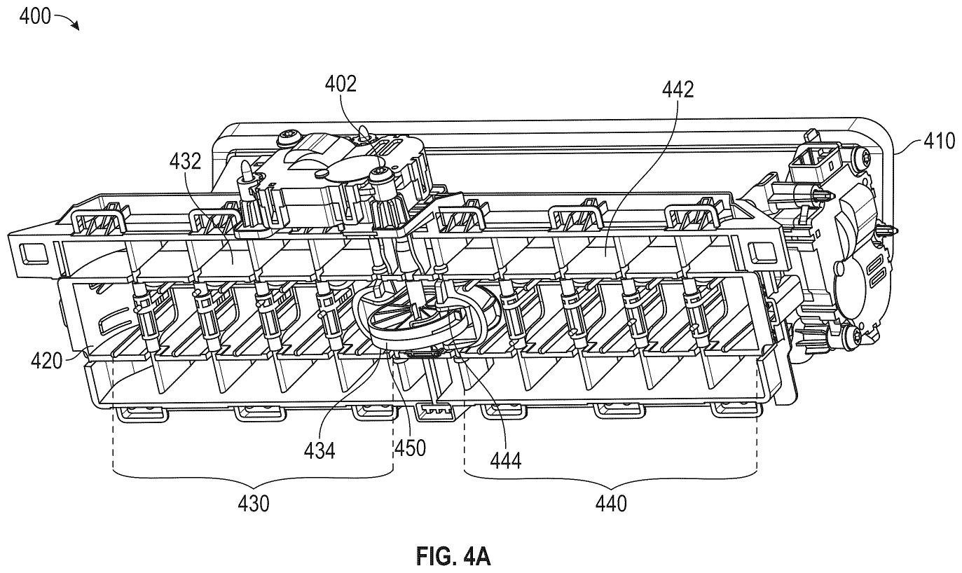

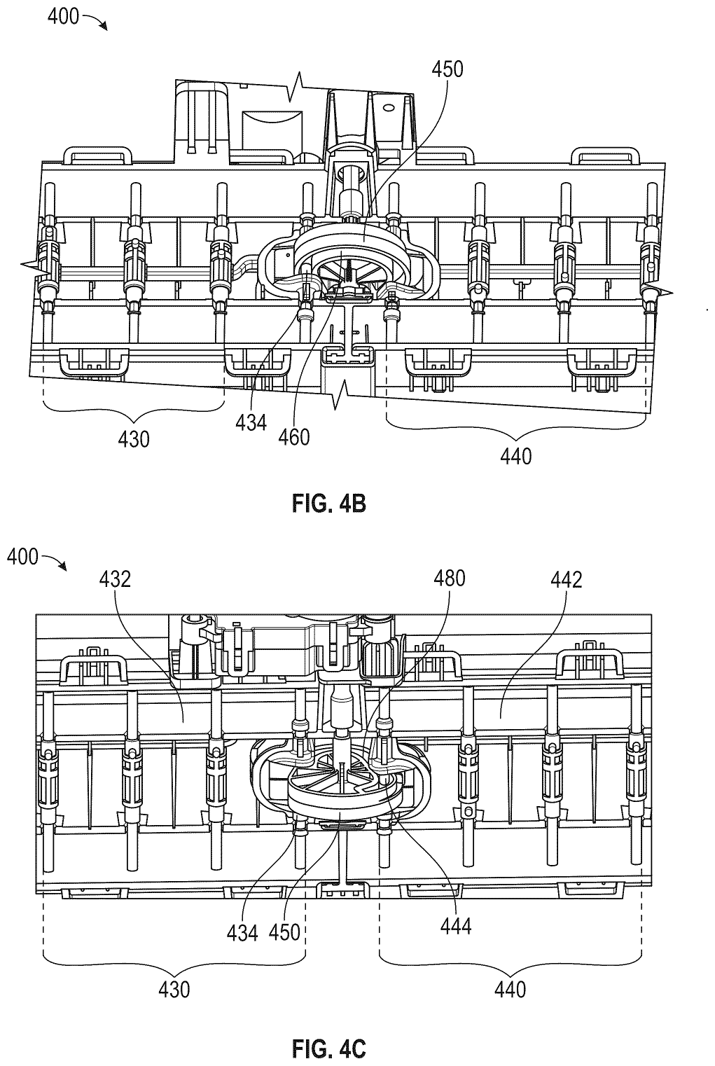

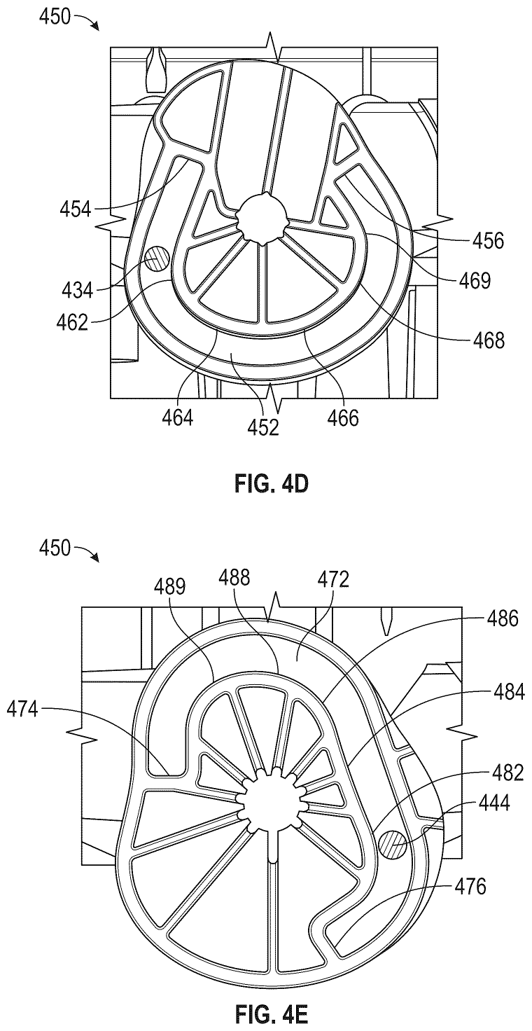

Referring now to FIGS. 4A-4E, a vent assembly can include a rotatable cam to control transitions between different configurations and to direct airflow in various directions. In some embodiments, the vent assembly 400 of FIGS. 4A-4E corresponds to some or all of the outlet vents 104 (e.g., some or all of the face vents 104VF, the floor vents 104F, the defrost vents 104D, and/or the rear vents 104VR) of FIGS. 1A-2. The different configurations provided by the vent assembly 400 of FIGS. 4A-4E can include the configurations illustrated in FIGS. 3A-3E.

As shown in FIGS. 4A, the vent assembly 400 can include multiple vanes, such as first vanes 430 and second vanes 440, each in a corresponding group or set (e.g., on a respective lateral side of the vent assembly 400). The first vanes 430 and the second vanes 440 can be controlled simultaneously to transition between one of multiple possible orientations to direct airflow from an inlet side 410 to an outlet side 420 of the vent assembly 400. While only two sets of vanes are illustrated, it will be understood that the vent assembly 400 can include any number of vanes and/or sets of vanes with coordinated control abilities.

As further shown in FIG. 4A, the first vanes 430 can be coupled to a cam 450 and/or to each other with a first arm 432, and the second vanes 440 can also be coupled to the cam 450 and/or to each other with a second arm 442. A rotational orientation of the cam 450 can urge each of a first follower 434 and a second follower 444, which can thereby move the first arm 432 and the second arm 442 to control rotation of the first vanes 430 and the second vanes 440. The rotational orientation of the cam 450 can be actively controlled, for example, by a motor 402 that is connected to the cam 450 (e.g., by a coaxial shaft and/or by one or more linking mechanisms, such as gears).

As shown in FIG. 4B, the first vanes 430 can be coupled to a first (e.g. upper or lower) cam portion 460 of the cam 450. In some embodiments, the first arm 432 can extend to and/or through each of the first vanes 430, such that a position of the first arm 432 can influence and/or control an orientation of each of the first vanes 430. For example, movement of the first arm 432 can apply a torque to each of the first vanes 430 to control rotation thereof about respective pivots and/or hinges. In some embodiments, a first follower 434 can extend from the first arm 432 to engage the cam 450 at the first cam portion 460. The rotational orientation of the cam 450 can urge the first follower 434, which can thereby move the first arm 432, which can thereby rotate the first vanes 430.

As shown in FIG. 4C, the second vanes 440 can be coupled to a second (e.g. lower or upper) cam portion 480 of the cam 450. The second cam portion 480 can be positioned on a side of the cam 450 is opposite the side defining the first cam portion 460. In some embodiments, the second arm 442 can extend to and/or through each of the second vanes 440, such that a position of the second arm 442 can influence and/or control an orientation of each of the second vanes 440. For example, movement of the second arm 442 can apply a torque to each of the second vanes 440 to control rotation thereof about respective pivots and/or hinges. In some embodiments, a second follower 444 can extend from the second arm 442 to engage the cam 450 at the second cam portion 480. The rotational orientation of the cam 450 can urge the second follower 444, which can thereby move the second arm 442, which can thereby rotate the second vanes 440.

It should be recognized that the first cam portion 460 and the second cam portion 480 can provide engagement with the first follower 434 and the second follower 444, respectively. Such engagement can be maintained simultaneously, such that rotation of the cam 450 can simultaneously urge and/or actuate the first follower 434 and the second follower 444 and thereby simultaneously control the orientations of the first vanes 430 and the second vanes 440. By providing different cam portions (e.g., the first cam portion 460 and the second cam portion 480), each rotational configuration of the cam 450 can provide separate forces on the respective followers and sets of vanes, such that different orientations of the vanes can be achieved with a given orientation of the cam 450.

As shown in FIG. 4D, the cam 450 can include the first cam portion 460 having multiple lobes to form a first shape, with the first follower 434 abutting, engaging, and/or being biased against one of the lobes of the first cam portion 460. For example, the first cam portion 460 can include a first lower lobe 462, a second lower lobe 464, a third lower lobe 466, and/or a fourth lower lobe 468. Each of the lobes can define a structure (e.g., a wall) that is a respective distance from a central axis of the cam 450, wherein at least one of the distances is different from a respective distance from the central axis of at least one of the lobes. Accordingly, as the cam 450 rotates to align different ones of the lobes with the first follower 434, the first follower 434 is urged to a respective distance from the central axis of the cam 450, and the first vanes are urged to a corresponding rotational orientation. For example, alignment of the first follower 434 with the first lower lobe 462 can correspond to the alignment of the first vanes according to the neutral configuration as illustrated in FIG. 3A. By further example, alignment of the first follower 434 with the second lower lobe 464 can correspond to the alignment of the first vanes according to the first configuration as illustrated in FIG. 3B. By further example, alignment of the first follower 434 with the third lower lobe 466 can correspond to the alignment of the first vanes according to the second configuration as illustrated in FIG. 3C. By further example, alignment of the first follower 434 with the fourth lower lobe 468 can correspond to the alignment of the first vanes according to the third configuration as illustrated in FIG. 3D. By further example, alignment of the first follower 434 with the fifth lower lobe 469 can correspond to the alignment of the first vanes according to the fourth configuration as illustrated in FIG. 3E.

In some embodiments, the first cam portion 460 provides a first track 452 (e.g., groove, wall, and/or other structure) to abut and/or urge the first follower 434. The first track 452 can include a recessed portion that receives the first follower 434 and is at least partially defined by one or more lobes of the first cam portion 460. In some embodiments, the first track 452 can define a first terminal end 454 and a second terminal end 456 at opposing ends of the first track 452. As the first follower 434 abuts either of the first terminal end 454 or the second terminal end 456, a force can be detected (e.g., by the motor and/or a sensor). The vent assembly and/or a controller connected thereto can calibrate (e.g., determine a calibration factor for) the motor connected to the cam 450, so that the controls needed to align the first follower 434 with a given lobe can be determined and executed.

As shown in FIG. 4E, the cam 450 can include the second cam portion 480 having multiple lobes to form a second shape, with the second follower 444 abutting, engaging, and/or being biased against one of the lobes of the second cam portion 480. The shape defined by the second cam portion 480 can be different than a shape defined by the first cam portion 460, such that different configurations (e.g., actuations) can be provided for any given orientation of the cam 450. For example, the second cam portion 480 can include a first upper lobe 482, a second upper lobe 484, a third upper lobe 486, and/or a fourth upper lobe 488. Each of the lobes can define a structure (e.g., a wall) that is a respective distance from a central axis of the cam 450, wherein at least one of the distances is different from a respective distance from the central axis of at least one of the lobes. Accordingly, as the cam 450 rotates to align different ones of the lobes with the second follower 444, the second follower 444 is urged to a respective distance from the central axis of the cam 450, and the second vanes are urged to a corresponding rotational orientation. For example, alignment of the second follower 444 with the first upper lobe 482 can correspond to the alignment of the second vanes according to the neutral configuration as illustrated in FIG. 3A. By further example, alignment of the second follower 444 with the second upper lobe 484 can correspond to the alignment of the second vanes according to the second configuration as illustrated in FIG. 3B. By further example, alignment of the second follower 444 with the third upper lobe 486 can correspond to the alignment of the second vanes according to the second configuration as illustrated in FIG. 3C. By further example, alignment of the second follower 444 with the fourth upper lobe 488 can correspond to the alignment of the second vanes according to the third configuration as illustrated in FIG. 3D. By further example, alignment of the second follower 444 with the fifth upper lobe 489 can correspond to the alignment of the second vanes according to the fourth configuration as illustrated in FIG. 3E.

A given lobe of the second cam portion 480 can correspond to a given lobe of the first cam portion 460. For example, while the first follower 434 is aligned with the first lower lobe 462, the second follower 444 is aligned with the first upper lobe 482. By further example, while the first follower 434 is aligned with the second lower lobe 464, the second follower 444 is aligned with the second upper lobe 484. By further example, while the first follower 434 is aligned with the third lower lobe 466, the second follower 444 is aligned with the third upper lobe 486. By further example, while the first follower 434 is aligned with the fourth lower lobe 468, the second follower 444 is aligned with the fourth upper lobe 488. Accordingly, the configuration of the cam 450 can bring each of the followers into alignment with a target lobe so the corresponding vanes have the target orientation.

In some embodiments, the second cam portion 480 provides a second track 472 (e.g., groove, wall, and/or other structure) to abut and/or urge the second follower 444. The second track 472 can include a recessed portion that receives the second follower 444 and is at least partially defined by one or more lobes of the second cam portion 480. In some embodiments, the second track 472 can define a first terminal end 474 and a second terminal end 476 at opposing ends of the second track 472. As the second follower 444 abuts either of the first terminal end 474 or the second terminal end 476, a force can be detected (e.g., by the motor and/or a sensor). The vent assembly and/or a controller connected thereto can calibrate (e.g., determine a calibration factor for) the motor connected to the cam 450, so that the controls needed to align the second follower 444 with a given lobe can be determined and executed.

In some embodiments, the first follower 434 and/or the second follower 444 can be biased against the cam 450. In some embodiments, the corresponding cam portions provide controlled restraint on the first follower 434 and/or the second follower 444 (e.g., with walls facing each other).

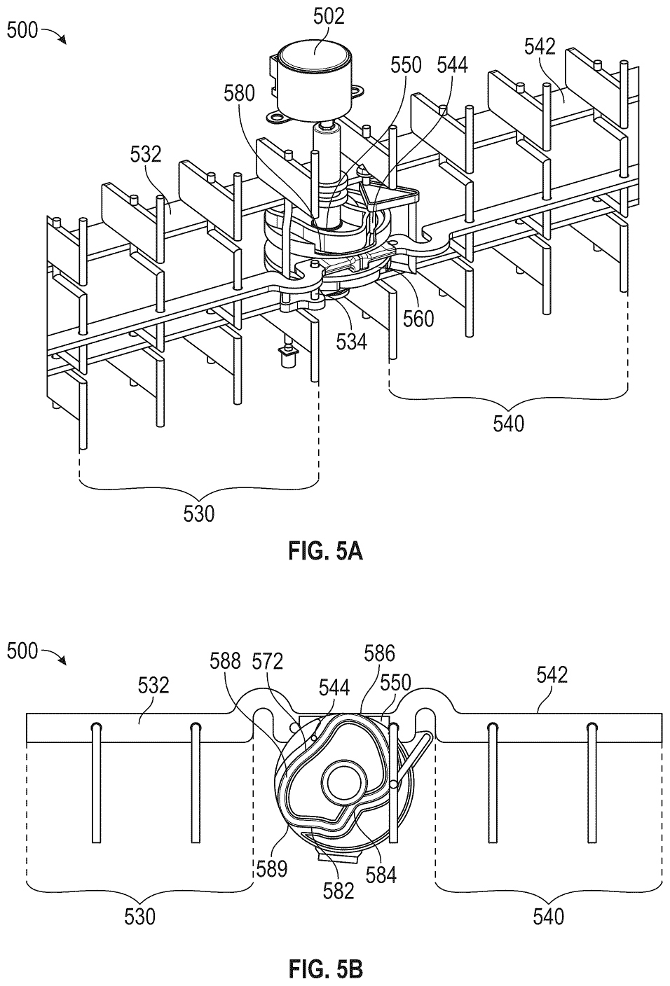

Referring now to FIGS. 5A and 5B, a vent assembly can include a rotatable cam to control transitions between different configurations and to direct airflow in various directions. In some embodiments, the vent assembly 500 of FIGS. 5A and 5B corresponds to some or all of the outlet vents 104 (e.g., some or all of the face vents 104VF, the floor vents 104F, the defrost vents 104D, and/or the rear vents 104VR) of FIGS. 1A-2. The different configurations provided by the vent assembly 500 of FIGS. 5A and 5B can include the configurations illustrated in FIGS. 3A-3E.

As shown in FIGS. 5A, the vent assembly 500 can include multiple vanes, such as first vanes 530 and second vanes 540, each in a corresponding group or set (e.g., on a respective lateral side of the vent assembly 500). The first vanes 530 and the second vanes 540 can be controlled simultaneously to transition between one of multiple possible orientations to direct airflow. While only two sets of vanes are illustrated, it will be understood that the vent assembly 500 can include any number of vanes and/or sets of vanes with coordinated control abilities.

As further shown in FIG. 5A, the first vanes 530 can be coupled to a cam 550 and/or to each other with a first arm 532, and the second vanes 540 can also be coupled to the cam 550 and/or to each other with a second arm 542. A rotational orientation of the cam 550 can urge each of a first follower 534 and a second follower 544, which can thereby move the first arm 532 and the second arm 542 to control rotation of the first vanes 530 and the second vanes 540. The rotational orientation of the cam 550 can be actively controlled, for example, by a motor 502 that is connected to the cam 550 (e.g., by a coaxial shaft and/or by one or more linking mechanisms, such as gears).

As further shown in FIG. 5A, the first vanes 530 can be coupled to a first (e.g. upper or lower) cam portion 560 of the cam 550, and the second vanes 540 can be coupled to a second (e.g. lower or upper) cam portion 580 of the cam 550. The rotational orientation of the cam 550 can urge the first follower 534, which can thereby move the first arm 532, which can thereby rotate the first vanes 530. The rotational orientation of the cam 550 can also urge the second follower 544, which can thereby move the second arm 542, which can thereby rotate the second vanes 540.

As shown in FIG. 5B, the cam 550 can include the second cam portion 580 having multiple lobes to form a second shape, with the second follower 544 abutting, engaging, and/or being biased against one of the lobes of the second cam portion 580. The shape defined by the second cam portion 580 can be different than a shape defined by the first cam portion 560, such that different configurations (e.g., actuations) can be provided for any given orientation of the cam 550. For example, the second cam portion 580 can include a first upper lobe 582, a second upper lobe 584, a third upper lobe 586, a fourth upper lobe 588, and/or a fifth upper lobe 589. Each of the lobes can define a structure (e.g., a wall) that is a respective distance from a central axis of the cam 550, wherein at least one of the distances is different from a respective distance from the central axis of at least one of the lobes. Accordingly, as the cam 550 rotates to align different ones of the lobes with the second follower 544, the second follower 544 is urged to a respective distance from the central axis of the cam 550, and the second vanes are urged to a corresponding rotational orientation. For example, alignment of the second follower 544 with the first upper lobe 582 can correspond to the alignment of the second vanes according to the neutral configuration as illustrated in FIG. 3A. By further example, alignment of the second follower 544 with the second upper lobe 584 can correspond to the alignment of the second vanes according to the second configuration as illustrated in FIG. 3B. By further example, alignment of the second follower 544 with the third upper lobe 586 can correspond to the alignment of the second vanes according to the second configuration as illustrated in FIG. 3C. By further example, alignment of the second follower 544 with the fourth upper lobe 588 can correspond to the alignment of the second vanes according to the third configuration as illustrated in FIG. 3D. By further example, alignment of the second follower 544 with the fifth upper lobe 589 can correspond to the alignment of the second vanes according to the fourth configuration as illustrated in FIG. 3E.

In contrast to the cam of FIGS. 4A-4E, the cam 550 of FIG. 5B can include a continuous track that extends about an entire periphery of the cam 550 (e.g., at the second cam portion 580). For example, each of the first upper lobe 582, the second upper lobe 584, the third upper lobe 586, the fourth upper lobe 588, and the fifth upper lobe 589 can be joined to an adjacent pair of other lobes from the foregoing list. Accordingly, the cam 550 can be rotated in either direction to arrive at the target rotational orientation and/or to align the second follower 544 with the target lobe. By providing the neutral, first, second, third, and fourth configurations with different rotational orientations of the cam, the cam 550 can be operated to transition from any one of the configurations to any other one of the configurations. Such transitions do not require cycling through all of the configurations. For example, from any one of the configurations, the cam 550 can be transitioned directly to another one by rotating the cam 550 in the appropriate direction. This provides an ability to travel to the target configuration along the shortest path to achieving the desired configuration and the fewest number of transitions. A correspondingly similar configuration (e.g., continuous track) can be provided at the first cam portion while still providing a different lobed shape than does the second cam portion 580.

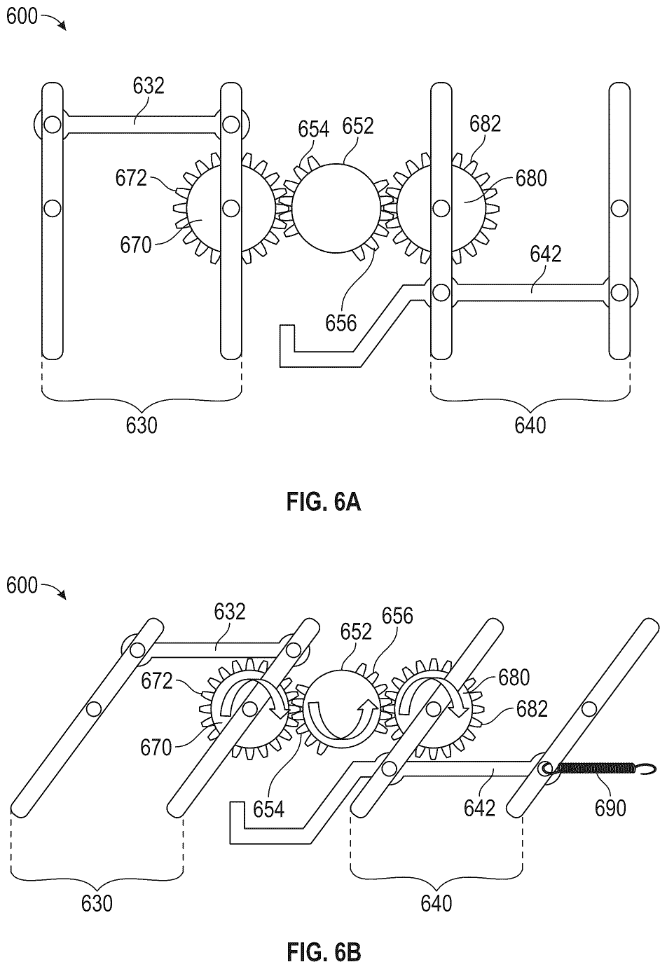

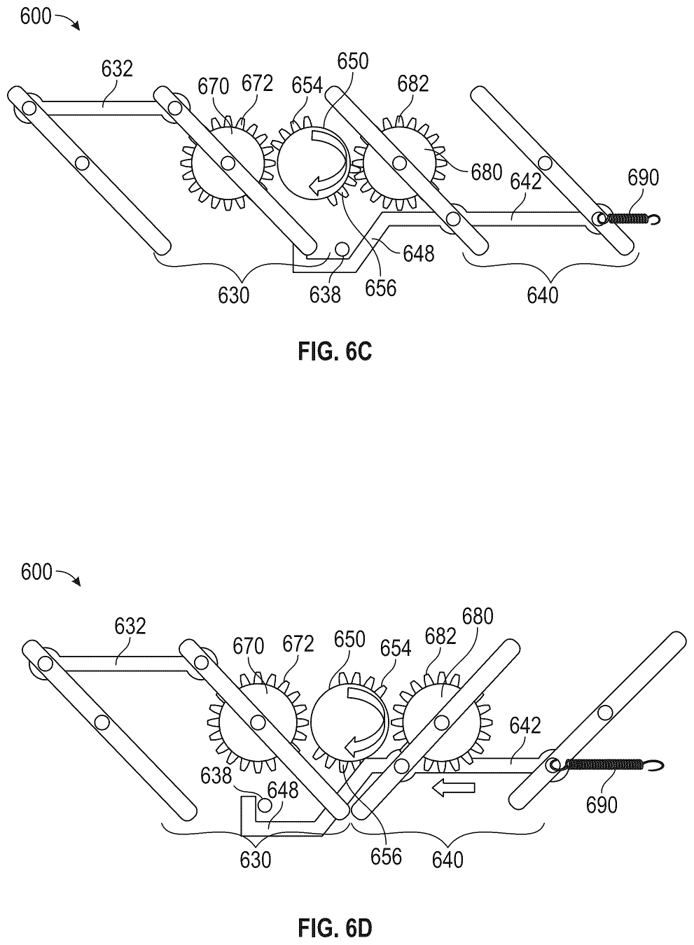

Referring now to FIGS. 6A-6D, a vent assembly can include a rotatable gear to control transitions between different configurations and to direct airflow in various directions. In some embodiments, the vent assembly 600 of FIGS. 6A-6D corresponds to some or all of the outlet vents 104 (e.g., some or all of the face vents 104VF, the floor vents 104F, the defrost vents 104D, and/or the rear vents 104VR) of FIGS. 1A-2. The different configurations provided by the vent assembly 600 of FIGS. 6A-6D can include the configurations illustrated in FIGS. 3A-3E.

As shown in FIGS. 6A-6D, a vent assembly 600 can include multiple vanes, such as first vanes 630 and second vanes 640, each in corresponding groups. The multiple first vanes 630 can be coupled to a first outer gear 670 and/or to each other with a first arm 632. The multiple second vanes 640 can be coupled to a second outer gear 680 and/or to each other with a second arm 642. An inner gear 652 can include first inner teeth 654 for selectively engaging the first outer gear 670 and second inner teeth 656 for selectively engaging the second outer gear 680. The first inner teeth 654 and the second inner teeth 656 can extend about a portion of the periphery of the inner gear 652, and portions of the inner gear 652 can include no teeth, such that at particular rotational orientations of the inner gear 652, the inner gear 652 does not engage the teeth of the first outer gear 670 and/or the second outer gear 680.

The inner gear 652 can further include an engager 638 for selectively engaging one of the arms, such as the second arm 642 that is coupled to the second vanes 640. For example, the engager 638 can be coupled to other portions of the inner gear 652, including the first inner teeth 654 and the second inner teeth 656 with a joining structure (not shown). The engager 638 can rotate with other portions of the inner gear 652, including the first inner teeth 654 and the second inner teeth 656. At particular rotational orientations of the inner gear 652, the engager 638 may not engage the second arm 642, and at other rotational orientations of the inner gear 652, the engager 638 can engage the second arm 642.

The inner gear 652 is configured to be rotated to transition the apparatus between each of multiple configurations. As shown in FIG. 6A, the vent assembly 600 can provide a neutral configuration of the first vanes 630 and the second vanes 640. For example, in a first configuration of the inner gear 652, the first inner teeth 654 engage the first outer teeth 672 of the first outer gear 670 to provide a neutral orientation of the first outer gear 670. By further example, in the first configuration of the inner gear 652, the second inner teeth 656 engage the second outer teeth 682 of the second outer gear 680 to provide a neutral orientation of the second outer gear 680. Such a configuration can correspond to the alignment of the first vanes and the second vanes according to the neutral configuration as illustrated in FIG. 3A.

As shown in FIG. 6B, the vent assembly 600 can provide a first configuration with the first vanes 630 and the second vanes 640 facing a first direction while the first inner teeth 654 engage the first outer gear 670 and the second inner teeth 656 engage the second outer gear 680. For example, in a second configuration of the inner gear 652, the first inner teeth 654 engage the first outer teeth 672 of the first outer gear 670 to provide a first orientation of the first outer gear 670. By further example, in the second orientation of the inner gear 652, the second inner teeth 656 engage the second outer teeth 682 of the second outer gear 680 to provide the first orientation of the second outer gear 680. Such a configuration can correspond to the alignment of the first vanes and the second vanes according to the first configuration as illustrated in FIG. 3B.

As shown in FIG. 6C, the vent assembly 600 can provide a second configuration with the first vanes 630 and the second vanes 640 facing a second direction, different than the first direction, while the first inner teeth 654 engage the first outer gear 670 and the second inner teeth 656 engage the second outer gear 680. For example, in a third configuration of the inner gear 652, the first inner teeth 654 engage the first outer teeth 672 of the first outer gear 670 to provide a second orientation of the first outer gear 670. By further example, in the third configuration of the inner gear 652, the second inner teeth 656 engage the second outer teeth 682 of the second outer gear 680 to provide the second orientation of the second outer gear 680. Such a configuration can correspond to the alignment of the first vanes and the second vanes according to the second configuration as illustrated in FIG. 3C.

As shown in FIG. 6D, the vent assembly 600 can provide a third configuration with the first vanes 630 facing the first direction and the second vanes 640 facing the second direction while the engager 638 (e.g., a pin) engages an arm (e.g., the second arm 442). While in the third configuration of FIG. 6D, the first inner teeth 654 of the inner gear 652 can disengage from the first outer teeth 672 of the first outer gear 670 and/or the second inner teeth 656 of the inner gear 652 can disengage from the second outer teeth 682 of the second outer gear 680 to allow rotation control by other mechanisms, such as by the engager 638 and/or a biaser 690. For example, the first arm 432 and the second arm 442 can be biased (e.g., with a spring) away from or toward the inner gear 652. As further shown in FIG. 6D, the biaser (e.g., a spring) 690 can bias the second arm 642 to the first orientation, and the engagement between the engager 638 and an engagement portion 648 of the second arm 642 can overcome the biasing force by moving the second arm 642 and the second vanes 640 to the second orientation. The rotation required to move the second arm 642 with the engager 638 can avoid direction interaction between the first inner teeth 654 of the inner gear 652 and the first outer teeth 672 of the first outer gear 670 and/or the second inner teeth 656 of the inner gear 652 and the second outer teeth 682 of the second outer gear 680 due to the spacing provided by the inner gear 650 at which no teeth are present. Such a configuration can correspond to the alignment of the first vanes and the second vanes according to the third configuration as illustrated in FIG. 3D. While the third configuration is shown with diverging airflow, the assembly can be configured to provide converging airflow as appropriate.

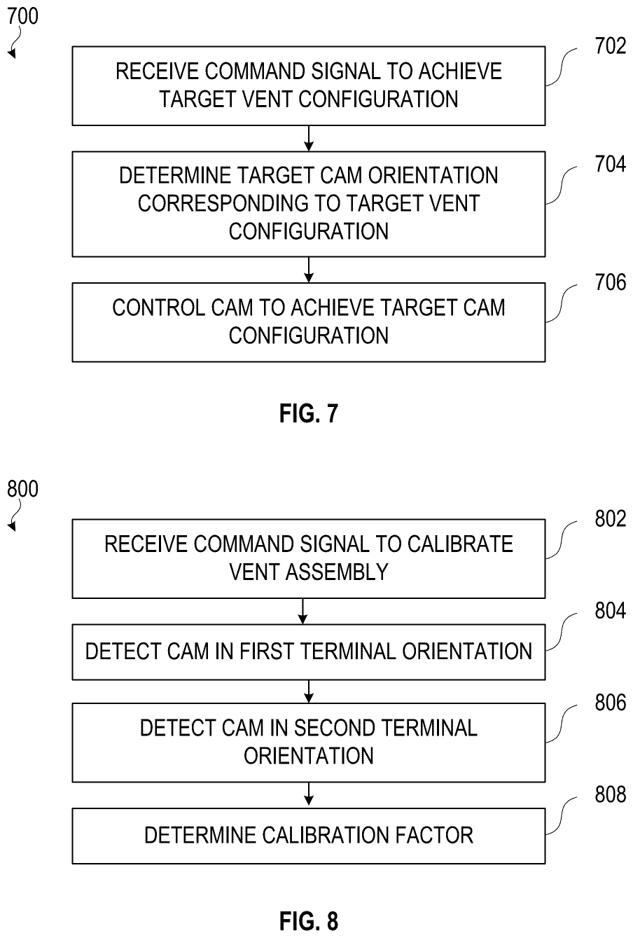

FIG. 7 illustrates a flow diagram of an example process for operating a ventilation system, in accordance with implementations of the subject technology. For explanatory purposes, the process 700 is primarily described herein with reference to the vehicle 100, the outlet vents 104, the blower 106, the inlet 112, and the processing circuitry 108 of FIGS. 1A-6. However, the process 700 is not limited to the vehicle 100, the vehicle 100, the outlet vents 104, the blower 106, the inlet 112, and the processing circuitry 108 of FIGS. 1A-6, and one or more blocks (or operations) of the process 700 may be performed by one or more other components of other suitable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, a target vent configuration may be determined (e.g., based on a received command signal). For example, the target vent configuration may be based on an input from a user, via a user interface of the vehicle 100, to the processing circuitry 108. In some embodiments, determining the target vent configuration may include determining one or more directions for directing airflow from one or more vents. In some embodiments, determining the target vent configuration may include determining a respective orientation for each of multiple vanes and/or sets of vanes.

At block 704, a target cam (and/or a gear) orientation can be determined. The target cam (and/or gear) orientation can correspond to the target vent configuration. For example, the processing circuitry 108 of the vehicle 100 can determine a direction and/or extent of rotation of a cam (and/or a gear) from a present orientation that is required to achieve the target cam (and/or gear) orientation. Such a determination can include determine which of multiple directions of rotation from the present orientation will provide the shortest and/or most rapid transition to the target cam (and/or gear) orientation.

At block 706, a cam (and/or a gear) can be controlled to achieve the target cam configuration and/or the target vent configuration. The control can be provided by operating a motor and/or other actuator to rotate a cam (and/or a gear). The achievement of the target cam configuration and/or the target vent configuration can be verified and/or adjustments can be made to achieve the target cam configuration and/or the target vent configuration.

FIG. 8 illustrates a flow diagram of an example process for calibrating a ventilation system, in accordance with implementations of the subject technology. For explanatory purposes, the process 800 is primarily described herein with reference to the vehicle 100, the outlet vents 104, the blower 106, the inlet 112, and the processing circuitry 108 of FIGS. 1A-6. However, the process 800 is not limited to the vehicle 100, the vehicle 100, the outlet vents 104, the blower 106, the inlet 112, and the processing circuitry 108 of FIGS. 1A-6, and one or more blocks (or operations) of the process 800 may be performed by one or more other components of other suitable apparatuses, devices, or systems. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, calibration can be initiated, for example, by receiving a command signal (e.g., at the processing circuitry 108). Calibration can be initiated in response to a predetermined setting, a schedule, a detected condition, and/or a user selection.

At block 804, a cam (and/or a gear) can be rotated to a first terminal orientation. For example, as a cam (and/or a gear) is rotated in a first direction, a follower or other structure can abut a first terminal end of a track or other cam portion. In response, a force can be detected (e.g., by the motor and/or a sensor). Such a force can include a reaction force opposing further rotation of the cam (and/or the gear).

At block 806, the cam (and/or a gear) can be rotated to a second terminal orientation. For example, as the cam (and/or a gear) is rotated in a second direction, the follower or other structure can abut a second terminal end of the track or other cam portion. In response, a force can be detected (e.g., by the motor and/or a sensor). Such a force can include a reaction force opposing further rotation of the cam (and/or the gear).

At block 808, a calibration factor can be determined. As the forces at the terminal orientations are detected, the corresponding rotational orientations of the cam (and/or the gear) can be recorded. The location of each lobe of the cam can be determined based on their known location relative to the first and second terminal ends. Further operation of the motor can be based on the calibration factor, so that the target orientations and configurations can be achieved with accuracy.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
one or more first vanes;
one or more second vanes;
a first follower coupled to each of the one or more first vanes;
a second follower coupled to each of the one or more second vanes; and
a rotatable cam including:
a first cam portion having multiple first lobes to form a first shape, the first follower engaging the first cam portion; and
a second cam portion having multiple second lobes to form a second shape, different than the first shape, the second follower engaging the second cam portion.

2. The apparatus of claim 1, wherein the rotatable cam is configured to be rotated to transition the apparatus between:
a first configuration with the one or more first vanes and the one or more second vanes facing a first direction;
a second configuration with the one or more first vanes and the one or more second vanes facing a second direction, different than the first direction; and
a third configuration with the one or more first vanes facing the first direction and the one or more second vanes facing the second direction.

3. The apparatus of claim 2, wherein, in the third configuration, the one or more first vanes and the one or more second vanes are directed to provide a diverging flow of air.

4. The apparatus of claim 2, wherein, in the third configuration, the one or more first vanes and the one or more second vanes are directed to provide a converging flow of air.

5. The apparatus of claim 1, wherein:
the first cam portion is on a first side of the cam; and
the second cam portion is on a second side of the cam, opposite the first side.

6. The apparatus of claim 1, further comprising:
a first arm coupling each of the one or more first vanes to the first follower; and
a second arm coupling each of the one or more second vanes to the second follower.

7. The apparatus of claim 1, wherein the rotatable cam defines:
a first channel extending about the first cam portion, the first channel having a first terminal end and a second terminal end; and
a second channel extending about the second cam portion, the first channel having a third terminal end and a fourth terminal end.

8. The apparatus of claim 1, wherein:
the multiple first lobes are distributed about a continuous first outer periphery of the first cam portion; and
the multiple second lobes are distributed about a continuous second outer periphery of the second cam portion.

9. The apparatus of claim 1, further comprising:
a first spring configured to bias the first follower against the first cam portion; and
a second spring configured to bias the second follower against the second cam portion.

10. The apparatus of claim 1, wherein the one or more first vanes and the one or more second vanes are each located within a passenger compartment of a vehicle.

11. A method comprising:
rotating a cam to a first orientation to urge one or more first vanes and one or more second vanes to a first configuration with the one or more first vanes and the one or more second vanes facing a first direction;
rotating the cam to a second orientation to urge the one or more first vanes and the one or more second vanes to a second configuration with the one or more first vanes and the one or more second vanes facing a second direction, different than the first direction; and
rotating the cam to a third orientation to urge first vanes and second vanes to a third configuration with the one or more first vanes facing the first direction and the one or more second vanes facing the second direction.

12. The method of claim 11, wherein:
while the cam is in the first orientation, a first upper lobe of an upper cam portion of the cam urges the one or more first vanes to face the first direction and a first lower lobe of a lower cam portion of the cam urges the one or more second vanes to face the first direction;
while the cam is in the second orientation, a second upper lobe of the upper cam portion of the cam urges the one or more first vanes to face the second direction and a second lower lobe of the lower cam portion of the cam urges the one or more second vanes to face the second direction; and
while the cam is in the third orientation, a third upper lobe of the upper cam portion of the cam urges the one or more first vanes to face the first direction and a third lower lobe of the lower cam portion of the cam urges the one or more second vanes to face the second direction.

13. The method of claim 11, wherein:
rotating the cam to the first orientation is in response to a first command signal;
rotating the cam to the second orientation is in response to a second command signal; and
rotating the cam to the third orientation is in response to a third command signal.

14. The method of claim 11, further comprising:
detecting a current orientation of the cam;
determining a direction of rotation of the cam corresponding to a shortest rotational path to a target orientation, wherein the target orientation is one of the first orientation, the second orientation, or the third orientation; and
rotating the cam in the direction of rotation.

15. The method of claim 11, further comprising:
detecting when the cam is in a fourth orientation in which a follower abuts a first terminal end of the cam;
detecting the cam to a fifth orientation in which the follower abuts a second terminal end of the cam; and
in response to a detection of the fourth orientation and a detection of the fifth orientation, determining a calibration factor for controlling rotation of the cam to each of the first orientation, the second orientation, and the third orientation.

16. An apparatus comprising:
one or more first vanes coupled to a first outer gear;
one or more second vanes coupled to a second outer gear and an arm; and
an inner gear including:
first inner teeth for selectively engaging the first outer gear;
second inner teeth for selectively engaging the second outer gear; and
an engager for selectively engaging the arm.

17. The apparatus of claim 16, wherein the inner gear is configured to be rotated to transition the apparatus between:
a first configuration with the one or more first vanes and the one or more second vanes facing a first direction while the first inner teeth engage the first outer gear and the second inner teeth engage the second outer gear;
a second configuration with the one or more first vanes and the one or more second vanes facing a second direction, different than the first direction, while the first inner teeth engage the first outer gear and the second inner teeth engage the second outer gear; and
a third configuration with the one or more first vanes facing the first direction and the one or more second vanes facing the second direction while the engager engages the arm.

18. The apparatus of claim 17, further comprising a spring configured to bias the one or more second vanes to face in the second direction.

19. The apparatus of claim 16, wherein the first inner teeth and the second inner teeth are positioned on opposing sides of the inner gear.

20. The apparatus of claim 16. wherein the one or more first vanes and the one or more second vanes are each located within a passenger compartment of a vehicle.
